(19) United States
(12) Patent Application Publication
(10) Pub. No.: US 2004/0216374 A1
(43) Pub. Date: Nov. 4, 2004

(54) Hydroponic container

(75) Inventor: Joseph Davids, Vaucluse (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Galuku Pty Ltd, Vaucluse (AU)

(21) Appl. No.: 10/624,850

(22) Filed: Jul. 21, 2003

(30) Foreign Application Priority Data
Apr. 16, 2003 (AU) 2003203772

(51) Int. Cl. A01G 31/00

(52) U.S. Cl. 47/59 R

(57) ABSTRACT

An hydroponic container apparatus for growing plants therein comprises a block of dehydrated coir fibres placed in a container (10). The container (10) has drain holes (14) located in its base (11) and has an open top (13) from sides (12), the open top of the container being adapted to be folded and sealed such that the container (10) acts as packaging for the block of dehydrated coir fibres, and the sides (12) of the container are folded and secured over the top of the block. When the container (10) is ready for use it is unsealed and unfolded such that the dehydrated block of coir fibres is able to be re-hydrated and readied for use as a hydroponic medium whilst still in the container (10).

### FIELD OF THE INVENTION

The present invention relates to hydroponic growth mediums and, in particular to a hydroponic container system which uses so-called coir fibre pith or cocopeat as the growth medium within a plastics container whereby a slab of dehydrated processed cocopeat is formed in plastics packaging which is supplied to the user sealed, whereafter the user opens the packaging to form the container with an open top and proceeds to expand and condition the cocopeat prior to planting. The packaging in which the cocopeat is supplied forms the container in which the plants are grown hydroponically which obviates the need for handling of the cocopeat.

### BACKGROUND OF THE INVENTION

In the horticultural industry it is known to use so-called coir fibre pith or cocopeat as the growth medium. Cocopeat is a natural and renewable resource produced by the coconut industry. Cocopeat is produced as a byproduct when coconut husks are processed for the extraction of the long fibres from the husks where the cocopeat is the binding material that comes from the fibre fraction of the coconut husk.

The coir fibre pith is washed, heat treated, screened and graded for horticultural and agricultural applications. The cocopeat is formed of millions of capillary micro-sponges which absorb and hold up to eight times its weight in water and as such is a suitable product to be used as an hydroponic growth medium for plants.

Cocopeat can be used in the hydroponic growing of plants in a variety of ways. The cocopeat can be placed in specialised containers, pots, or styrene boxes whereby the cocopeat is re-hydrated bales or blocks. Such usage requires handling and installation of the cocopeat into the requisite or specialised container.

It is seen that it would be advantageous to provide the cocopeat in packaging which can be used as the growing container as it provides the most economic and efficient method of growing hydroponic crops.

### OBJECT OF THE INVENTION

It is an object of the present invention to provide an hydroponic container which provides the above mentioned advantages. At the very least, the invention provides an alternative to previously known methods and systems.

### DISCLOSURE OF THE INVENTION

According to one aspect of the present invention, there is disclosed an hydroponic container apparatus for growing plants therein, said apparatus comprising a block of dehydrated coir fibres placed in a container, said container having sides and base and an open top, drain hole means being located in its base, the container being adapted to be folded and sealed such that the container acts as packaging for the block of dehydrated coir fibres, the sides of the container being folded and secured over the top of the block, wherein the container when it is ready for use is adapted to be unsealed and unfolded such that the dehydrated block of coir fibres is able to be re-hydrated and readied for use as a hydroponic medium whilst still in the container.

According to another aspect of the present invention there is disclosed a method of growing plants hydroponically, said method including the steps of providing a block of dehydrated coir fibres placed in a container having a base and side(s) and an open top, said base having drain hole means located therein, folding side(s) on top of the block and sealing to form packaging of the block, unsealing the folded sides to form an open topped container, re-hydrating and readying the block of coir fibres to receive plants therein.

### BRIEF DESCRIPTION OF THE DRAWINGS

Some embodiments of the invention will now be described with reference to the accompanying draws in which:

FIG. 1 is a perspective view of a container of a preferred embodiment shown as packaging for the cocopeat;

FIG. 2 is a perspective view of the container of FIG. 1 shown being opened;

FIG. 3 is a perspective view of the container of FIG. 1 shown in the process of hydrating the cocopeat;

FIG. 4 is a perspective view of the container of FIG. 1 shown in the process of conditioning the cocopeat; and

FIG. 5 is a partial perspective view of the container of FIG. 1 shown with a plant being grown hydroponically.

### BEST MODE OF CARRYING OUT THE INVENTION

A hydroponic container or planterbag 10 is illustrated in the drawings. The container 10 is formed with a base 11, four sides 12 and an open top 13. Naturally, the number of sides can be varied. The base 11 has drainage holes 14 as the container 10 is made from impervious plastics material.

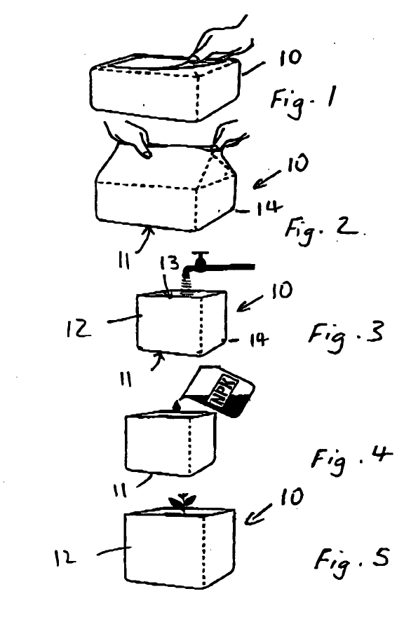

In the preferred form of the invention, hydroponic medium such as cocopeat is placed in the container 10 whereby the cocopeat or coir fibre has been processed and dehydrated. Naturally other types of growth mediums can be used. The sides 11 of the container 10 are then folded over the cocopeat and is sealed as seen in the packaged container 10 in FIG. 1. The sealed container 10 is then suitable for sale and shipment.

When the container 10 is to be readied for use, the container 10 is unsealed and opened as seen in FIGS. 1 and 2. The cocopeat is hydrated by pouring water into the container 10. A container 10 which has 9 litres of cocopeat in the container 10 when it is expanded requires approximately 4 litres of water to hydrate to full expansion.

The cocopeat in the container is then conditioned whereby, the electrical conductivity or CE of the irrigation water is measured and when the EC of the runoff water, though the drainage holes 14 is substantially the same, the cocopeat is then sufficiently flushed and ready for charging which is done before planting.

The cocopeat is charged with a full nutrient solution. The recommended nutrient strength for charging is an EC of 1.0 to 1.5. The charging process is generally stopped when the runoff matches nutrient strength of the irrigation water.

The container 10 is then ready for use and the planting end growth management is done in accordance with accepted practices.

The container 10 can be used for one or more plants according to the type of plant and the crop requirements. It is desired to grow more than one plant per container 10, the container 10 can be accordingly increased in size.

Throughout the specification, the word “comprise” and its derivatives are intended to have an inclusive rather than an exclusive meaning unless the context requires otherwise.

The foregoing describes only some embodiments of the present invention, and modifications obvious to those skilled in the art can be made thereto without departing from the scope of the present invention.

1. An hydroponic container apparatus for growing plants therein, said apparatus comprising a block of dehydrated coir fibres placed in a container, said container having sides and base and an open top, drain hole means being located in its base, the container being adapted to be folded and sealed such that the container acts as packaging for the block of dehydrated coir fibres, the sides of the container being folded and secured over the top of the block, wherein the container when it is ready for use is adapted to be unsealed and unfolded such that the dehydrated block of coir fibres is able to be re-hydrated and readied for use as a hydroponic medium whilst still in the container.

2. The apparatus according to claim 1, wherein the container is made from impervious plastics material.

3. The apparatus according to claim 2, wherein the drain hole means are holes punched into the base of the container.

4. The apparatus according to claim 1, wherein the block of dehydrated coir material is rectangular in form.

5. The apparatus according to claim 1, wherein the apparatus is used for more than one plant.

6. A method of growing plants hydroponically, said method including the steps of providing a block of dehydrated coir fibres placed in a container having a base and side(s) and an open top, said base having drain hole means located therein, folding side(s) on top of the block and sealing to form packaging of the block, unsealing the folded sides to form an open topped container, re-hydrating and readying the block of coir fibres to receive plants therein.
